(19) United States
(12) Patent Application Publication
(10) Pub. No.: US 2016/0217633 A1
(43) Pub. Date: Jul. 28, 2016

(54) CARD-TYPE SMART KEY APPARATUS AND CONTROL METHOD THEREOF

(71) Applicant: CONTINENTAL AUTOMOTIVE GMBH, Hannover (DE)

(72) Inventor: SungMin Jang, Gyeonggi-do, Ichoen (KR)

(73) Assignee: Continental Automotive GmbH, Hannover (DE)

(21) Appl. No.: 15/025,327

(22) PCT Filed: Oct. 1, 2014
(86) PCT No.: PCT/EP2014/071090

§ 371 Date: Mar. 28, 2016

(30) Foreign Application Priority Data
Oct. 1, 2013 (KR) 10-2013-0117576

(51) Int. Cl. G07C 9/00; B60R 25/24

(52) U.S. Cl. CPC G07C 9/0069; B60R 25/24; G08C 2201/94

(57) ABSTRACT

A card-type smart key apparatus and a control method thereof are provided. The card-type smart key apparatus includes a card-type main body, a wireless communication unit provided in the main body and configured to perform wireless communication with a passive keyless entry (PKE) system of a vehicle, a touch sensing unit installed on at least one of two sides of the main body and configured to sense a touch signal, and a control unit configured to transmit a wakeup signal to the vehicle through the wireless communication unit according to the touch signal sensed by the touch sensing unit.

### CROSS-REFERENCE TO RELATED APPLICATION

This application is the U.S. National Phase Application of PCT International Application No. PCT/EP2014/071090, filed Oct. 1, 2014, which claims priority to Korean Patent Application No. 10 2013 0117576, filed Oct. 1, 2013, the contents of such applications being incorporated by reference herein.

### FIELD OF THE INVENTION

The present invention relates to a card-type smart key apparatus and a control method thereof, and more particularly, to a card-type smart key apparatus and a control method thereof that can easily find a position of a vehicle by outputting a wakeup signal to the vehicle according to a touch pattern in which a touch sensing unit formed in a card-type smart key is touched.

### BACKGROUND OF THE INVENTION

In general, a passive keyless entry (PKE) system serves as a vehicle security system provided to wirelessly control opening/closing of a vehicle at a position at which a driver or a vehicle owner is near the vehicle, and is used to unlock a door of the vehicle and start the vehicle.

Here, the PKE system is provided to find a smart key using a low frequency (LF) antenna when the smart key carried by a user is at a position near a vehicle, and perform a control operation of automatically unlocking or locking a door of the vehicle or starting the vehicle when the smart key is authenticated as a smart key appropriate for the vehicle.

That is, the PKE system is a system capable of wirelessly controlling unlocking/locking of a door of a vehicle and starting of the vehicle without intervention of an additional operation in which a user operates a remote controller or the like even when no separate mechanical key is used if the user has the authenticated smart key or card-type smart key.

Also, the PKE system finds whether the smart key is located inside or outside the vehicle using the LF antenna so as to unlock or lock a door of the vehicle or start the vehicle.

The background technology of the present invention is disclosed in Korean Patent Publication No. 2012-0140063, which is incorporated by reference (entitled “Smart key system and method using smart key” published on Dec. 28, 2012).

### SUMMARY OF THE INVENTION

Because a plurality of buttons are provided in a smart key, the user may execute a relevant control function of the vehicle by pressing an appropriate button.

That is, when the user is located within a predetermined distance from the vehicle, a door of the vehicle is locked if a door lock button is pressed, a door of the vehicle is unlocked if a door unlock button is pressed, and the trunk of the vehicle is opened when a trunk open button is pressed.

In addition, when a warning button is provided, it is possible to output a warning sound in the vehicle to provide a notification of a dangerous situation.

When the relevant control function of the vehicle is executed by pressing a button in the smart key as described above, a buzzer sounds and an emergency light flashes so that an operation state of the vehicle may be identified.

Accordingly, many drivers are also using smart keys for the purpose of finding positions of their vehicles using a plurality of buttons provided in the smart keys.

In particular, when the vehicle is parked in a spacious parking lot, the smart key is conveniently used to find the vehicle by causing the buzzer to sound or causing the emergency light to flash.

However, for a card-type smart key, there is a problem in that the above-described function cannot be used because it is difficult to install buttons because of a thin thickness of the card-type smart key of less than 4 mm.

The present invention has been made to solve the above-described problem, and an aspect of the invention provides a card-type smart key apparatus and a control method thereof that can easily find a position of a vehicle by outputting a wakeup signal to the vehicle according to a touch pattern of a touch sensing unit formed in a card-type smart key.

Another aspect of the invention provides a card-type smart key apparatus and a control method thereof that can provide a plurality of touch modules so as to prevent touch errors in a touch sensing unit and prevent the touch errors by defining various touch patterns. Still another objective of the invention is to provide a card-type smart key apparatus and a control method thereof that can reduce battery consumption as well as touch errors.

According to an aspect of the present invention, there is provided a card-type smart key apparatus including: a card-type main body; a wireless communication unit provided in the main body and configured to perform wireless communication with a PKE system of a vehicle; a touch sensing unit installed on at least one of two sides of the main body and configured to sense a touch signal; and a control unit configured to transmit a wakeup signal to the vehicle through the wireless communication unit according to the touch signal sensed by the touch sensing unit.

In an embodiment of the present invention, the touch sensing unit is a capacitive sensing type.

In an embodiment of the present invention, the touch sensing unit includes a plurality of touch modules.

In an embodiment of the present invention, a mark representing a region in which the plurality of touch modules are formed is formed on an outside of the main body.

In an embodiment of the present invention, the control unit transmits the wakeup signal by determining a touch pattern sensed from the plurality of touch modules.

In an embodiment of the present invention, the control unit transmits the wakeup signal based on the number of inputs of a touch signal sensed through the touch sensing unit for a set time.

In an embodiment of the present invention, the wakeup signal is at least one of a buzzer operating signal and an emergency light flashing signal.

The card-type smart key apparatus may further include a tact switch provided in the main body, wherein the control unit activates the touch sensing unit only for a set time when the tact switch operates.

According to an aspect of the present invention, there is provided a method of controlling a card-type smart key apparatus, including: sensing, by a control unit, a touch signal through a touch sensing unit; comparing a touch pattern of the touch signal to a set touch pattern when the touch signal is sensed; and transmitting a wakeup signal through a wireless communication unit when the touch pattern of the touch signal matches the set touch pattern.

In an embodiment of the present invention, in sensing the touch signal, the touch sensing unit is activated only for a set time when a tact switch operates.

In an embodiment of the present invention, the step of comparing includes performing a comparison with the order of inputs sensed from a plurality of touch modules of the touch sensing unit.

In an embodiment of the present invention, the step of comparing includes performing a comparison with the number of inputs of a touch signal sensed through the touch sensing unit for a set time.

In an embodiment of the present invention, the wakeup signal is at least one of a buzzer operating signal and an emergency light flashing signal.

In the card-type smart key apparatus and the control method thereof according to the present invention, it is possible to easily find a position of the vehicle by forming the touch sensing unit in a card-type smart key and outputting the wakeup signal to the vehicle according to the touch pattern in which the touch sensing unit is touched.

In addition, according to an aspect of the present invention, it is possible to prevent a touch error by providing the plurality of touch modules and defining various touch patterns and prevent an erroneous operation by preventing the touch error in the touch sensing unit.

In addition, according to an aspect of the present invention, it is possible to reduce battery consumption as well as a touch error by activating the touch sensing unit for the set time only when the tact switch operates.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block configuration diagram illustrating a card-type smart key apparatus according to an exemplary embodiment of the present invention;

FIG. 2 is an exemplary diagram illustrating a sensor module formed on one side of a card-type smart key according to an exemplary embodiment of the present invention;

FIG. 3 is an exemplary diagram illustrating an input pattern of a touch signal using the card-type smart key according to an exemplary embodiment of the present invention; and

FIG. 4 is a flowchart illustrating a method of controlling the card-type smart key apparatus according to an exemplary embodiment of the present invention.

### DETAILED DESCRIPTION OF EXEMPLARY EMBODIMENTS

Hereinafter, an exemplary embodiment of a card-type smart key apparatus and a control method thereof according to the present invention will be described with reference to the accompanying drawings. In the description, the thicknesses of lines or the sizes of elements etc. shown in the drawings may be illustrated in an enlarged manner for the clarity and convenience of the description.

Also, terms described below, which are defined considering functions in the present invention, can have a different meaning depending on a user's or operator's intention or practice. Therefore, it should be understood that the terms are to be defined based on the disclosure throughout this specification.

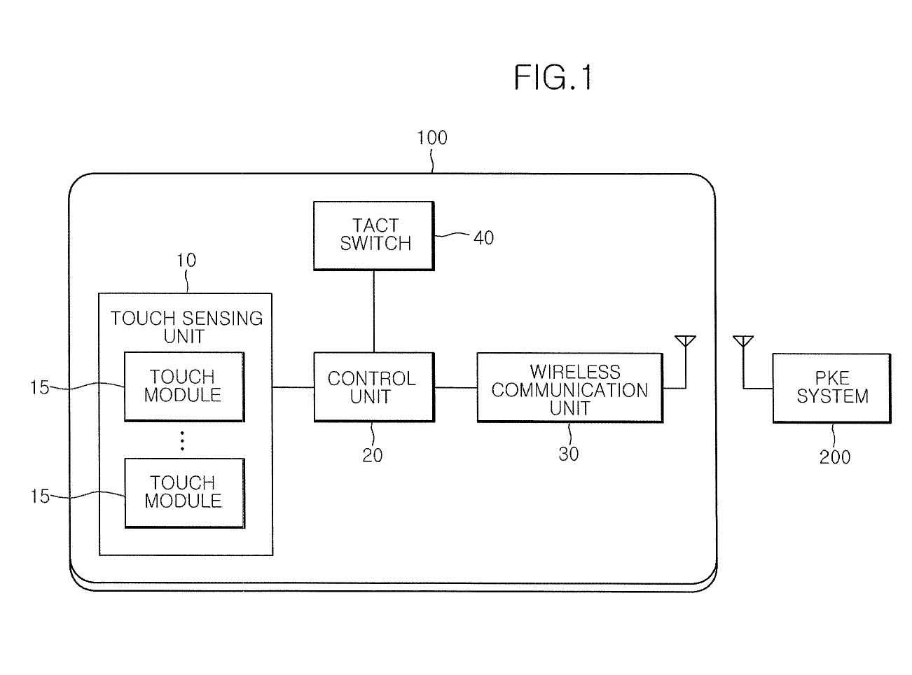

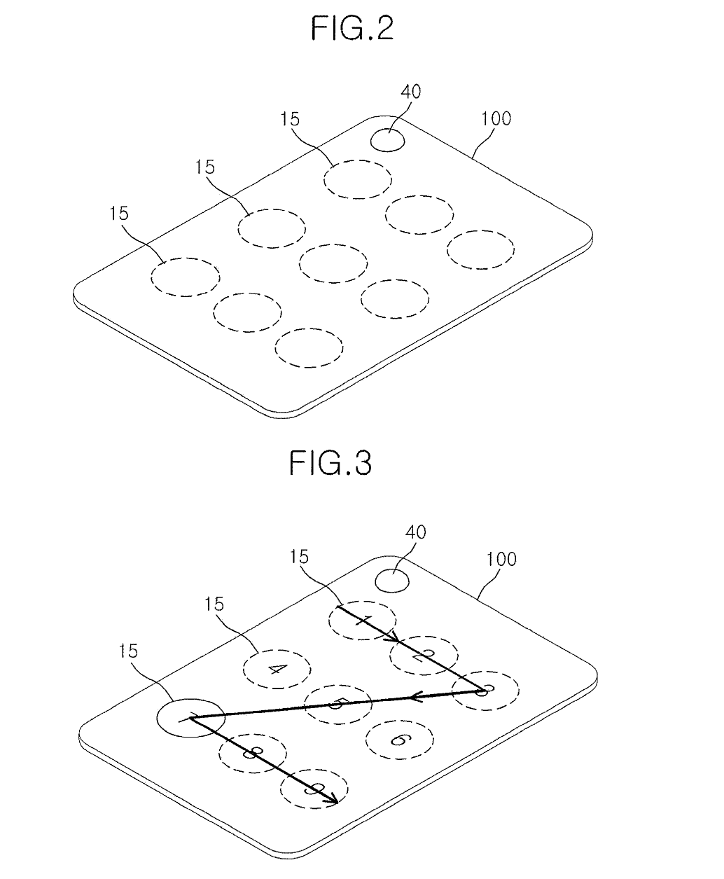

FIG. 1 is a block configuration diagram illustrating a card-type smart key apparatus according to an exemplary embodiment of the present invention, FIG. 2 is an exemplary diagram illustrating a sensor module formed on one side of a card-type smart key according to an exemplary embodiment of the present invention, and FIG. 3 is an exemplary diagram illustrating an input pattern of a touch signal using the card-type smart key according to an exemplary embodiment of the present invention.

As illustrated in FIGS. 1 to 3, the card-type smart key apparatus according to the exemplary embodiment of the present invention includes a tact switch 40 as well as a main body 100, a touch sensing unit 10, a control unit 20, and a wireless communication unit 30.

In general, the main body 100 is constituted of a thin structure having a thickness of less than 4 mm in a card type.

The wireless communication unit 30 is provided inside the main body 100, and performs wireless communication with a PKE system 200 of a vehicle through an LF antenna (not illustrated) and a radio frequency (RF) antenna (not illustrated). In addition, the wireless communication unit 30 may perform wireless communication through other known or unknown communication means.

The touch sensing unit 10 installed on at least one of two sides of the main body 100 senses a touch signal.

Here, although the touch sensing unit 10 may sense and provide the touch signal through one touch module 15 in a capacitive sensing type, a touch order may be sensed along with touch signals when the touch sensing modules 15 are touched by regularly arranging a plurality of touch modules 15 as illustrated in FIG. 2 so as to prevent touch errors.

Accordingly, an erroneous operation is prevented by determining whether a touch pattern is a user-intended touch pattern or a touch error pattern due to an erroneous touch of the user carrying the card-type smart key.

On the other hand, the tact switch 40 is installed in the card-type main body 100 in the form of a mechanical button, and the control unit 20 enables the touch sensing unit 10 to be activated only for a set time, for example, 5 sec, and to sense a touch signal when the user presses the tact switch 40, thereby preventing the erroneous operation.

When the set time has elapsed, the touch sensing unit 10 is deactivated again and therefore no touch signal is sensed even when the touch is performed.

In the card-type main body 100, a mark representing a region in which the touch modules 15 are formed may be formed in the form of unevenness or embossing on an outside of the main body 100.

The control unit 20 enables the vehicle to be started by transmitting an authentication key responsive to a request of the PKE system 200 through the wireless communication unit 30.

In addition, the control unit 20 enables a position of the vehicle to be conveniently found by transmitting a wakeup signal to the vehicle according to a touch signal sensed by the touch sensing unit 10 and causing the buzzer to sound or causing the emergency light to flash in the vehicle.

Here, the wakeup signal is at least one of a buzzer operating signal and an emergency light flashing signal, and various signals other than the buzzer operating signal and the emergency light flashing signal may also be used as long as the vehicle's position may be found by visually or audibly checking a state in which the vehicle operates from the wakeup signal.

The control unit 20 transmits the wakeup signal when the touch pattern matches the touch pattern set according to the order of inputs from the plurality of touch modules 15.

That is, when numbers are sequentially set in the touch modules as illustrated in FIG. 3, the order in which touch signals are input becomes 1, 2, 3, 5, 7, 8, and 9. Accordingly, the wakeup signal may be configured to be transmitted when the touch pattern matches the set touch pattern by setting the touch pattern according to the order of touch signals input as described above.

On the other hand, when the touch sensing unit 10 is formed of one touch module 15, the control unit 20 may transmit the wakeup signal when the number of touch signals sensed through the touch sensing unit 10 in a set time is a set number.

For example, the wakeup signal may be configured to be transmitted when a touch signal is input twice in 1 sec.

As described above, in the card-type smart key apparatus according to the embodiment of present invention, a touch sensing unit is formed in the card-type smart key and a touch pattern in which the touch sensing unit is touched is defined, and thus it is possible to easily find a position of the vehicle by outputting the wakeup signal when the touch pattern matches the defined touch pattern and to prevent an erroneous operation by preventing touch errors.

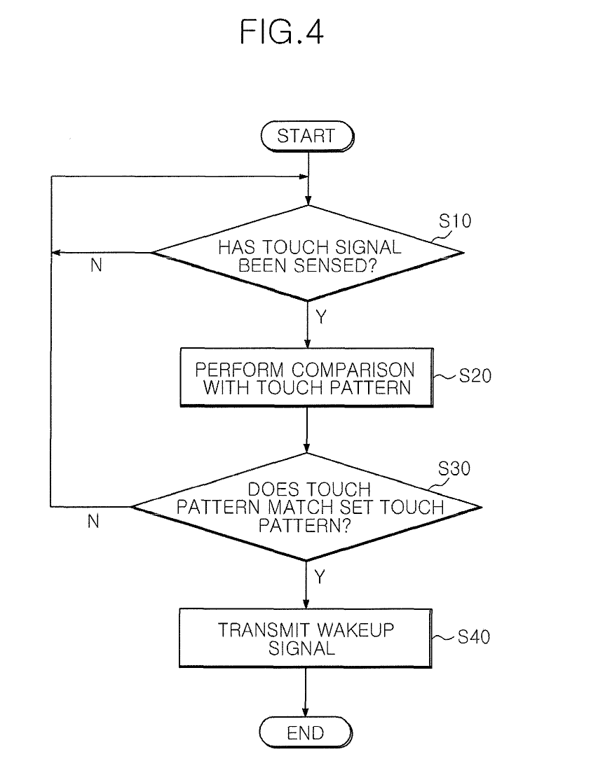

FIG. 4 is a flowchart illustrating a method of controlling the card-type smart key apparatus according to an exemplary embodiment of the present invention.

As illustrated in FIG. 4, the method of controlling the card-type smart key apparatus according to the exemplary embodiment of the present invention is provided.

First, the control unit 20 senses a touch signal through the touch sensing unit 10 (S10).

Here, when the tact switch 40 is provided in the card-type main body 100, the control unit 20 receives an input of an operation state of the tact switch 40 and activates the touch sensing unit 10 for a set time only when the tact switch 40 operates. Thereby, the control unit 20 may be configured to sense the touch signal through the touch sensing unit 10.

When the touch signal is sensed, a comparison with a touch pattern according to the input order of touch signals or the number of inputs is performed (S20).

That is, when the touch sensing unit 10 is formed of a plurality of touch modules 15 as in FIG. 2, a comparison with a touch pattern according to the input order of touch signals is performed as in FIG. 3.

Alternatively, when the touch sensing unit 10 is formed of one touch module 15, a comparison with a touch pattern according to the number of inputs of a touch signal sensed through the touch sensing unit 10 in a set time may be performed.

When the touch pattern matches a set touch pattern in the comparison, the wakeup signal is transmitted through the wireless communication unit 30 (S30 and S40).

That is, the wakeup signal may be transmitted when the touch pattern is input in the order of 1, 2, 3, 5, 7, 8, and 9 as in FIG. 3, or the wakeup signal may be transmitted when the touch signal is input twice in 1 sec as the touch pattern.

As such, it is possible to conveniently find a position of the vehicle by transmitting a wakeup signal to the vehicle and causing the buzzer to sound or causing the emergency light to flash in the vehicle.

Here, the wakeup signal is at least one of a buzzer operating signal and an emergency light flashing signal, and various signals other than the buzzer operating signal and the emergency light flashing signal may also be used as long as the vehicle's position may be found by visually or audibly checking a state in which the vehicle operates from the wakeup signal.

As described above, in the method of controlling the card-type smart key apparatus according to the embodiment of the present invention, a touch sensing unit is formed in the card-type smart key and a touch pattern in which the touch sensing unit is touched is defined. Thus, it is possible to easily find a position of the vehicle by outputting the wakeup signal when the touch pattern matches the defined touch pattern, and to prevent an erroneous operation by preventing touch errors.

Although the present invention has been described with reference to the exemplary embodiments illustrated in the drawings, it will be apparent to those skilled in the art that various modifications can be made to the above-described exemplary embodiments of the present invention without departing from the spirit or scope of the invention. Thus, the present invention is intended to cover all such modifications provided they come within the scope of the appended claims and their equivalents.

1. A card-type smart key apparatus comprising:
a card-type main body;
a wireless communication unit provided in the main body and configured to perform wireless communication with a passive keyless entry (PKE) system of a vehicle;
a touch sensing unit installed on at least one of two sides of the main body and configured to sense a touch signal; and
a control unit configured to transmit a wakeup signal to the vehicle through the wireless communication unit according to the touch signal sensed by the touch sensing unit.

2. The card-type smart key apparatus of claim 1, wherein the touch sensing unit is a capacitive sensing type.

3. The card-type smart key apparatus of claim 1, wherein the touch sensing unit includes a plurality of touch modules.

4. The card-type smart key apparatus of claim 3, wherein a mark representing a region in which the plurality of touch modules are formed is formed on an outside of the main body.

5. The card-type smart key apparatus of claim 3, wherein the control unit transmits the wakeup signal by determining a touch pattern sensed from the plurality of touch modules.

6. The card-type smart key apparatus of claim 1, wherein the control unit transmits the wakeup signal based on the number of inputs of a touch signal sensed through the touch sensing unit for a set time.

7. The card-type smart key apparatus of claim 1, wherein the wakeup signal is at least one of a buzzer operating signal and an emergency light flashing signal.

8. The card-type smart key apparatus of claim 1, further comprising:
a tact switch provided at the main body,
wherein the control unit activates the touch sensing unit only for a set time when the tact switch operates.

9. A method of controlling a card-type smart key apparatus, comprising:
sensing, by a control unit, a touch signal through a touch sensing unit;
comparing a touch pattern of the touch signal to a set touch pattern when the touch signal is sensed; and
transmitting a wakeup signal through a wireless communication unit when the touch pattern of the touch signal matches the set touch pattern.

10. The method of claim 9, wherein, in sensing the touch signal, the touch sensing unit is activated only for a set time when a tact switch operates.

11. The method of claim 9, wherein the step of comparing includes performing a comparison with the order of inputs sensed from a plurality of touch modules of the touch sensing unit.

12. The method of claim 9, wherein the step of comparing includes performing a comparison with the number of inputs of a touch signal sensed through the touch sensing unit for a set time.

13. The method of claim 9, wherein the wakeup signal is at least one of a buzzer operating signal and an emergency light flashing signal.

14. The card-type smart key apparatus of claim 2, wherein the touch sensing unit includes a plurality of touch modules.

15. The card-type smart key apparatus of claim 4, wherein the control unit transmits the wakeup signal by determining a touch pattern sensed from the plurality of touch modules.

16. The method of claim 10, wherein the step of comparing includes performing a comparison with the order of inputs sensed from a plurality of touch modules of the touch sensing unit.
